(19) United States
(12) Patent Application Publication
(10) Pub. No.: US 2008/0264930 A1
(43) Pub. Date: Oct. 30, 2008

(54) Electric Heating Structure

(75) Inventors: Francoise Mennechez, Orleans (FR); Jean-Pierre Odile, Villeneuve Sur Bellot (FR)

Correspondence Address: OBLON, SPIVAK, MCCLELLAND MAIER & NEUSTADT, P.C., 1940 DUKE STREET, ALEXANDRIA, VA, 22314, US

(73) Assignee: Saint-Gobain Glass France, Courbevoie (FR)

(21) Appl. No.: 11/575,144

(22) PCT Filed: Sep. 19, 2005
(86) PCT No.: PCT/FR05/50757

§ 371 Date: Apr. 16, 2008

(30) Foreign Application Priority Data
Sep. 17, 2004 (FR) 0409895

(51) Int. Cl. H05B 3/10

(52) U.S. Cl. 219/552

(57) ABSTRACT

An electric heating structure including a substrate and a heating element having a given specific resistance. The heating element includes an electrically conductive layer deposited on one of the faces of the substrate and supplied electrically, the heating element including a network of patterns functionally connected to the electrically conductive layer.

The present invention relates to an electric heating structure and more precisely concerns an electric heating structure comprising a substrate, a heating element having a given specific resistance and which comprises an electrically conductive layer deposited on one of the faces of the substrate and supplied electrically.

Electric heating glass panes are generally composed of a sheet of glass provided on one of its faces with an electric heating element used as such or having an anti-misting and/or anti-frosting function.

The heating element is sometimes obtained by depositing on the sheet of glass a conductive composition of the enamel type in the form of a suspension of metal particles such as silver particles, and glass frit in an organic binder, deposition being carried out by spraying, roller coating or curtain coating, or else by screen printing and by subjecting the glass coated in this way to baking at a temperature of the order of 500 to 650° C. Heating plates exist for example in the form of a winding conductive track in a narrow elongated crenellated form.

However, with such heating structures, the uniformity of heating in a given zone is poorly controlled. Moreover, if the track is interrupted the heating element is out of service. In addition, the enamel thickness is critical and difficult to adjust, and similarly the width of the track must be kept constant over all its length, which is restrictive and difficult to achieve. Finally, the resistance must be adjusted hot, taking a correction factor into account.

Alternatively, the heating element is an electrically conductive transparent layer having a suitable electrical resistance, for example a layer containing a metal oxide such as a fluorine-doped tin oxide which has a specific resistance or sheet resistance R1 of typically 10 to 15 ohms.

This thin layer is connected by electrically conductive elements to cables supplying current, these elements being termed connecting parts or lugs supplying current or distributing strips or “busbars”, which are generally positioned on two opposite sides of the layer. These elements will be designated hereinafter simply as “distributors”. These distributors are for example in the form of metal strips (for example in the form of tinned copper foil) attached for example by welding or adhesive bonding onto a glass pane, or in the form of screen printed metal strips.

The overall electrical resistance R of a heating element with a layer depends on the dimensions of the structure and is given by the following formula

R=R1×D/L

in which L corresponds to the length of the distributor and D the distance between distributors.

Document EP 0 936 022 A2 proposes an electric heating glass plane divided into two separate parts separated by a longitudinal break extending from one distributor to another in order to adjust the overall electrical resistance.

However, for a given power and/or for a given size and/or for a given supply voltage, making such a break is not always sufficient for obtaining specific heating characteristics.

The object of the invention is to provide an electric heating structure guaranteeing, according to the requirements, uniform heating at least on a given zone and/or one or more controlled heating heterogeneities, and also capable of operating over a wide range of sizes.

To this end, the invention provides an electric heating structure comprising:
a substrate,
a heating element having a given specific resistance and which comprises an electrically conductive layer deposited on one of the faces of the substrate and supplied electrically, the heating element comprising a network of patterns functionally connected to the electrically conductive layer.

Coupling the conductive layer and the network of patterns according to the invention makes possible, according to the case, either a fine adjustment of the specific resistance (and therefore the overall resistance) or one or more adjustments to the equivalent specific resistance of a predetermined zone or zones, independently of the aspect ratio of the surface D/L.

Thus, by widening the achievable range of specific resistance(s), the invention makes it possible to arrive, easily and simply, at the desired heating characteristics for an extensive range of products of different sizes and in various applications.

In this way, it is possible to choose to make conductive patterns in order to obtain a hotter zone, with an equivalent specific resistance less than that of a single uniform layer, or to make insulating patterns in order to obtain a colder zone with an equivalent specific resistance greater than that of a single uniform layer.

For example, if a high specific resistance value is desired, a very thin uniform layer chosen would present problems of heating uniformity. The network of patterns according to the invention makes it possible to adapt the resistance to an acceptable layer thickness.

Conversely, if a low specific resistance value is desired, known conductive layers alone do not allow low specific resistance values to be obtained that are for example less than 10 ohms, particularly when a visibility zone is necessary, since above a certain thickness they become opaque, and/or when mechanical strength and/or air resistance is/are required. The network of patterns according to the invention makes it possible to adapt the specific resistance to a limited layer thickness, with the possibility of retaining partial transparency and/or of preserving high robustness where required.

The network of patterns according to the invention also serves in many configurations:
in order to modify the existing layer which will be unsuitable for the desired heating temperature on account of its incorrect sheet resistance,
in order to correct an existing “imperfect” layer, for example in the case of a little known or poorly controlled thickness,
in order to create differentiated controlled heating zones, in particular by adapting the equivalent specific resistance in a zone of the layer to said network of patterns and by adapting the specific resistance in a zone of the layer without a network, termed an unmodified zone.

The network of patterns can serve to create a uniform temperature over the surface or differentiated surface power densities, or differentiated temperatures that are heating temperatures or a heating temperature and a temperature in a non-functional zone.

In the present description a network of patterns according to the invention is understood to mean, as against a random arrangement of varied patterns, a (virtually periodic repetition of a given geometric pattern or a similar or equivalent pattern (at the surface), the periodicity being defined as the distance between the center of two adjacent patterns.

The pattern can be un-dimensional (a single period) or preferably two-dimensional (two periods).

The network can also be multiple and thus combine several forms of geometric patterns, for example in the form of interlaced networks, it also being possible for the geometric pattern to be variable.

The heating structure can include a heating element according to the invention on each face of the substrate, with an identical or different design.

In addition, the substrate can also receive a coating having another functionality. It can consist of a coating having the function of blocking radiation with a wavelength in the infrared (using for example one or more layers of silver surrounded by dielectric layers, or nitride layers, such as TiN or ZrN layers, or layers made of metal oxides or steel or an alloy Ni—Cr), it can have low-emissivity function (for example a doped metal oxide such as SnO₂:F or tin-doped indium oxide (ITO) or one or more layers of silver), it can have an anti-misting function (with the aid of a hydrophilic layer) it can have an anti-soiling function (photocatalytic coating comprising TiO₂ at least partially crystallized in the anatase form) or alternatively it can be an anti-reflecting stack of the Si₃N₄/SiO₂/Si₃N₄/SiO₂ type for example.

In a preferred embodiment, the patterns have a rounded shape.

This shape, chosen for example to be circular, oval or elliptical, provides the best possible uniformity of current density distribution in the zone carrying the network, the number of hot spots being more numerous with dotted shapes.

A heating structure can for example be chosen with a network of patterns such that the heating current lines are mainly rectilinear “macroscopically” in the sense that the lines are not diverted by multiple breaks. Thus, the network does not substantially modify the path of the current and this therefore avoids the necessity of carrying out simulation work in order to obtain the desired thermal result, in particular in terms of uniformity with respect to the geometry of the substrate.

Preferably, the patterns can have a maximum size of 5 mm, even more preferably between 0.5 and 3 mm, in order to limit hot spots capable of generating thermal breakdown, particularly for domestic electrical appliances such as radiators.

According to one feature, the patterns can be arranged in a staggered manner forming in this way uniformly distributed current lines.

The centers of four adjacent patterns can be placed at the four corners of a square or a diamond.

The patterns can for example be arranged in parallel lines with distributors positioned at opposite sides of the layer, on the lateral or longitudinal edges of the substrate.

The network of patterns can cover a given area, the degree of coverage of the area lying preferably between 5 and 70% and even more preferably between in 10% and 40%, in particular when the network covers a large area. The degree of coverage is therefore adjusted to correspond to the total area of all the patterns over the total area occupied by the network of patterns, according to the desired equivalent specific resistance.

As an example, starting with a network of conductive patterns (for example spots of silver with a diameter of 1 mm, 2.1 mm apart) on a fluorine-doped tin layer with a normal resistance R1 equal to 10 ohms and having a degree of coverage equal to 5 or 17%, an adapted equivalent specific resistance R1 is obtained of 9.5 and 7.5 ohms respectively.

Also by way of example, from a network of patterns corresponding to holes, for example circular holes, made in a fluorine-doped tin layer with a normal resistance R1 equal to 10 ohms and having a degree of coverage equal to 13 or 30%, an adapted equivalent sheet resistance R1 of 12.5 and 20 ohms respectively is obtained. The same results are obtained with rings having an external diameter identical to the holes.

In an advantageous embodiment, the maximum size of the patterns diminishes, preferably progressively, in the direction of an unmodified zone of the layer.

An unmodified zone is understood to be a zone of a layer that is not associated with a network of patterns.

This reduction makes it possible for example to obtain a heating zone with a controlled thermal gradient effect and so a gentle transition with the unmodified zone.

It is possible to choose to produce a gradation of conductive patterns in order to obtain a hotter zone with a maximum of heating for example on the edges of the substrate and/or a gradation of insulating patterns in order to obtain a colder zone.

At least some of the patterns can be insulating discontinuities formed in at least one zone of the layer.

In this way deflectors are produced locally for the current flow by means of holes in the layer, or local insulating patterns of the layer giving conductive islands.

This makes it possible to increase the equivalent sheet resistance, for example in order to obtain a colder zone and/or a desired temperature.

Preferably, at least some of the insulating discontinuities can be rings, for example obtained by laser ablation, and/or disks, obtained for example by chemical etching.

The rings can be sufficiently fines similar to circles, in order to be virtually invisible to the naked eye, for example with a size less than the order of 100 μm. The impact on esthetics difference of color from the substrate) or even transparency (in particular with a substrate of the glass type) is then barely perceptible.

The insulating discontinuities can be holes. It can also be envisaged to fill the holes with an insulator that is in particular colored, for example for decorative purposes.

The structure having in its operating position an upper part and a lower part, the network comprising the insulating discontinuities can be provided in the upper part.

A zone with less heating in the upper part makes it possible to make the surface temperature uniform in the mounted position, for example by countering a natural convection effect or by reducing heating in a less sensitive upper zone.

At least some of the patterns of the network can be conductive dots having an electrical conductivity greater than that of the layer, the dots being positioned over at least one zone of the layer.

An alternative for forming a network with conductive patterns consists of filling the holes formed in the conductive layer with a material that is more conductive than the latter.

The conductive dots can be based on silver.

In a first possible configuration, the dots are made of silver enamel printed, for example, by screen printing, and baked. In this case, the patterns can also participate in a decoration.

Silver particles are preferred, in particular because they have an advantageous conductivity/cost ratio. It is also possible to choose an enamel containing other metal particles chosen from nickel, zinc, copper graphite or precious metals, such as gold, platinum or palladium.

In a variant, it is possible to choose an epoxy polyimide, silicone, polyester or polyacrylate resin, containing silver particles and baked between 100 and 200° C.

Enamel is preferred in particular if the substrate is a glass to be tempered since the enamel can withstand the temperatures required for thermal tempering (maximum temperature of about 650°).

In a second possible configuration, the dots can also be portions of a silver layer.

The substrate having, in the operating position, an upper part and a lower part, the network comprising the conductive dots can be provided in the lower part, for example in order to make the surface temperature in the mounting position uniform, for countering the natural convection effect, or for increasing heating in a more sensitive lower zone.

The network of patterns according to the invention can form a strip, preferably positioned along one edge of the substrate.

This edge can correspond to a zone of the structure that is particularly sensitive to condensation.

The network of patterns according to the invention can also form a round.

In this way, the network of patterns according to the invention makes it possible, with a suitable choice of the geometry and size of the patterns, to create a differentiated nonlinear heating zone which would not be possible from long breaks of the prior art.

According to an advantageous feature, the heating element being formed of at least two parts separated from each other by an insulating zone (for example a strip of bare substrate), the network of patterns is present in at least one of the two parts.

In this way, possibilities of obtaining the necessary heating characteristics are increased still further by making changes at the same time to the aspect ratio and to the specific resistance. The two parts can be identical or unequal.

When only one end of the insulating zone touches a distributor, changes are made to the aspect ratio both by increasing the distance D and by reducing the length L.

In addition, the substrate can be a transparent substrate and/or can be one having good heat resistance and/or can be thin and/or can be decorative, according to the requirements.

For example, the substrate can be a sheet of glass, or glass-ceramic, but also a sheet of plaster, wood or metal.

Moreover, a flexible heating film can comprise the conductive layer and the network of patterns according to the invention and be positioned for example between two plastic layers, for example made of polyester. This protected heating film can be in intimate contact by means of adhesive with a thermal insulator placed above as well as with a decorative material placed below. The heating film can also be included in a module.

Such a heating film serves for example for technical radiant heating, in particular of premises (plaster ceilings, suspended ceilings based on a module made of wood or stretched PVC etc.) or for domestic electrical appliances, for towel dryers or for defrosting, for example pipework, or for making packages frost-free. Naturally, the use of plastics limits the maximum temperature of use and the technologies for producing the layer and/or the network of patterns.

In a preferred embodiment, the electric heating structure corresponds to electric heating glazing comprising at least one glass sheet.

Glass can enable the structure to take up little space.

The glass can for example be soda-lime-silica glass or, particularly for applications requiring good temperature resistance (heating body, etc), borosilicate glass.

The glazing may comprise one or more sheets of glass and possibly one or more plastic sheets.

It consists for example of monolithic glazing comprising a tempered glass sheet or laminated glazing comprising at least two glass sheets separated by a plastic insert, or reinforced glazing additionally including at least one sheet having the required reinforcing properties.

The heating element can be situated on one face (or on both faces) of a glass sheet of the glazing and/or, where required, be situated on, or embedded in, a plastic insert of the glazing.

The glazing can be insulating under vacuum and can contain safety glass.

The structure can be a flat panel or it can be bowed.

The structure can be glazing having at least one visibility zone.

In a preferred embodiment, the structure can form one of the following elements: a lid for a refrigerated chests a glazed part for a refrigerated cabinet (door or wall) or a glazed part of a desk showcase.

The structure can also form one of the following elements: a glazed part for a heating shelf, a heating body for a radiator or radiant panel, a heating front for a towel dryer or radiator, an oven door, a plate-warmer, an element of interior fittings (separating wall, element incorporated into a module for a ceiling, floor, partition), a radiant heating element for a building or service compartment, an element for frost-prevention and/or for maintaining the temperature of sensitive products.

An all-glass radiator can be constructed including the electric heating structure according to the invention by way of a heating body and another integral glass sheet in decorative high-strength glass, of a chosen color. This radiator can be fixed in the floor, the wall or a ceiling or can be portable, on feet. This assembly can also serve as a towel dryer.

A hybrid heating body can also be constructed for a radiant panel that comprises a metal plate carrying a conventional electrical resistance and the structure according to the invention in the form of a monolithic heating pane.

In addition, the conductive layer can be a multilayer.

The conductive layer can be a metal layer that has a sufficient electrical resistance, or a semiconducting layer.

The conductive layer can be the layer sold by Saint-Gobain under the name “PLANITHERM”, of which the sheet resistance is equal to approximately 7 ohms, preferably in laminated or insulating glazing or double glazing.

Methods for depositing the conductive layer are all means known to a person skilled in art, in particular deposits made by coating with a paint, by powder coating, from a liquid, by dip coating, by spin coating, by flow coating or by PVD or CVD coating, etc.

Advantageously, said conductive layer can have a thickness (average) less than or equal to 1 μm, preferably less than or equal to 500 nm.

The conductive layer is preferably based on a metal oxide, preferably fluorine-doped tin oxide, or tin-doped indium oxide.

Such layers, generally obtained by the pyrolysis method (by a powder, liquid or CVD route) are chosen for their adhesion, stability, hardness, and mechanical strength and/or air resistance.

Other suitable layers can be chosen from the family of “TOCs” (transparent conductive oxides).

The conductive layer can be deposited directly on a substrate, in particular on a glass substrate, but a sub layer or any intermediate element can also be inserted.

The structure can benefit from the oriented emissivity of fluorine-doped tin oxide (flow oriented towards the part) for example in the case of a radiator front.

Other details and advantageous features of the invention will become apparent on reading the examples of devices illustrated in the following figures:

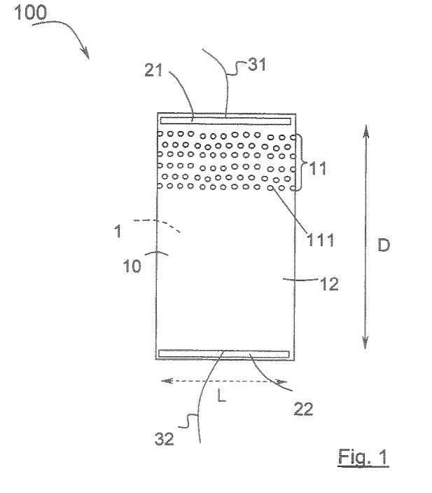

FIG. 1 shows schematically a heating front of a towel dryer of a first embodiment according to the invention;

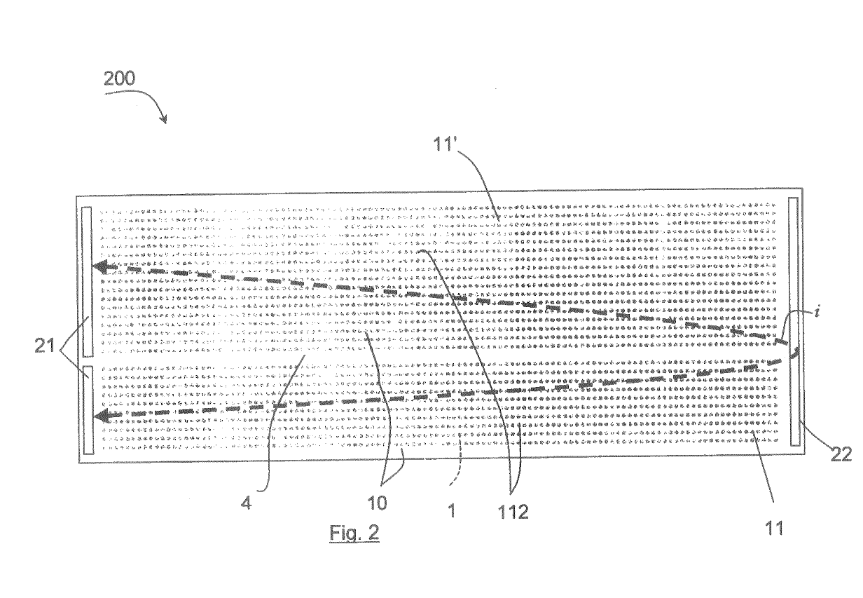

FIG. 2 shows schematically a heating body of a radiator in a second embodiment of the invention;

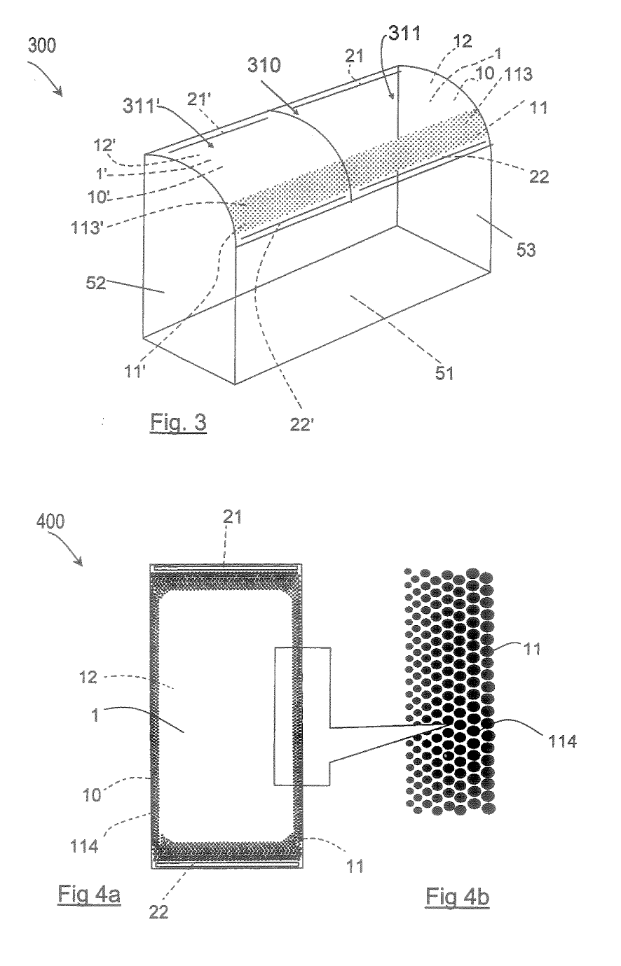

FIG. 3 shows schematically a refrigerated chest provided with an electric heating lid according to a third embodiment of the invention;

FIGS. 4a and 4b show schematically a cold door according to a fourth embodiment of the invention; and

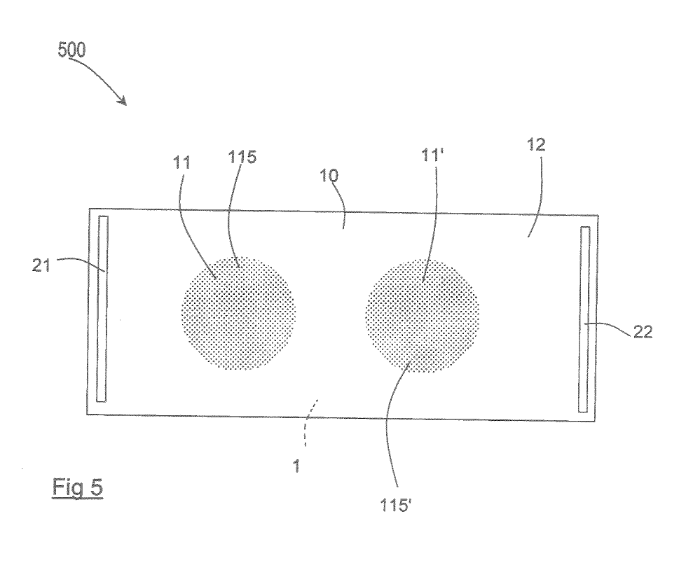

FIG. 5 shows schematically a plate warmer according to a fifth embodiment of the invention.

It should be stated first of all that, in the interests of clarity all the figures do not rigorously observe the proportions between the various elements shown. In addition, some elements of the electric heating structures described hereinafter (layer, network of patterns etc) are visible on account of the transparency of glass but are not shown by dotted lines in the interests of clarity. These elements are referenced by dotted reference lines.

FIG. 1 shows a heating front 100 of a towel dryer in a first embodiment of the invention.

The heating front 100 is composed of a 4 mm thick glass sheet 1 provided on one of its faces with a heating element composed of a layer of fluorine-doped tin oxide 10.

There are many methods for depositing thin conducting or semiconducting layers on glass. Several means are in particular known which enable organic salts to be pyrolysed on hot glass that are converted into conducting oxides. Among these, that of patent EP-0 125 153 enables a thin layer of fluorine-doped tin oxide to be deposited continuously on flat glass between the outlet from a float bath and the inlet to the annealing lehr. This method makes it possible to have glass plates with a transparent conductive layer of infinite dimensions for a low cost.

The layer can also be deposited in a repetitive manner for the purpose of more flexibility (choice of thickness, possible excess thickness etc) and also by other deposition techniques.

A first zone of the layer 10 comprises a network 11 of rings 111 made according to the known laser ablation technique so as to create regularly spaced islets. A second zone 12 of the layer 10 remains uniform.

The rings 111 are positioned in parallel lines with two metal strips forming distributors 21, 22 placed along the lateral edges of the glass sheet 1 and connected to the layer 10 and to electric cables 31, 32. Preferably the rings are not in contact with the strips 21, 22. In addition, the rings 111 are deposited in a staggered manner in order to avoid hot spots.

The thickness of the ring 111 is of the order of 100 m, and the external diameter is equal to 1 mm. The degree of coverage is 30%. The width of the first zone is 0.28 mm against 0.70 mm for the second zone 12.

With such a network, the current is not deflected and heating remains substantially uniform in each zone.

After mounting, the front is in the operating position in the length direction, and is for example vertical.

Everything else being equal if the layer 10 was uniform, the temperature difference associated with the natural convection effect would be of the order of 15° C. (80° C. for the upper part, 65° C. for the lower part).

The network 11 is positioned in the upper part of the front 100 so as to reduce the heating temperature in this zone, which makes it possible to compensate substantially for the temperature difference.

The distance D between the distributors being 980 mm and the width L of the distributors being 380 mm the equivalent specific resistance of this first zone is modified to a value of 65 ohms so as to obtain a theoretical heating temperature of 62° C. Its surface power density is 849 W/m².

The specific resistance of the second zone 12 is chosen to be equal to a value of 45 ohms in order to obtain a theoretical heating temperature of 76° C. Its surface power density is 1226 W/m².

Also, from input data which are the supply voltage of 230 V, the dimensions of the glass 1000×400 mm and a desired uniform temperature equal to approximately 70° C. over all the surface, the corresponding heating front 100 of the invention is produced with an actual temperature over all the surface of 69° C., by modifying (increasing) the equivalent specific resistance by engraving circles judicially positioned in the upper zone, as well as the specific resistance of the unmodified lower zone.

This heating front can be completed by a bar adjusted to the desired height in order to support a towel. This front can also serve as the heating front of a radiator.

FIG. 2 shows a heating body 200 of a radiator in a second embodiment of the invention.

The heating body 200 is composed of a 4 mm glass sheet 1 provided on one of its faces with a heating element composed of a layer of fluorine-doped tin oxide 10 with a thickness of approximately 500 nm, giving a specific resistivity of 10 ohms.

The heating element is divided into two separate parts by a strip 4 of bare glass. The area of the upper part is greater than the area of the lower part so as to create two differentiated heating zones and to connect electric cables (not shown) on the same side.

In addition, a split network 11, 11′ of enamel dots 112 based on silver, that are screen printed and baked, is formed on the layer 10.

The dots 112 are positioned in parallel lines with two metal strips forming distributors 21, 22, placed in the region of the lateral edges of the glass sheet and connected to the layer 10. The length of the distributor 21 in the upper (lower) part is 150 mm (120 mm respectively).

With a single end of the insulating zone touching a distributor 21, the aspect ratio is adjusted doubly by doubling the distance D and by reducing the width L.

The diameter of the dots 112 is 1 mm and the distance between the center of two adjacent dots is 2.1 mm. The dots have a thickness of approximately 10 μm, the precise thickness not being critical. A heat correction is not essential, given the large difference in resistance between silver and tin oxide. The degree of coverage is 17.5%.

This network 11, 11′ makes it possible to reduce the specific resistance to 7.5 ohms so as to obtain an overall power of 600 W.

With such a network, the current i is not substantially deflected in the lower and upper parts, and heating remains substantially uniform over all the surface area.

Also, from input data which are the supply voltage of 230 V, the glass dimensions 770×270 mm, a required connection on the same side, a heating power at 600 W and two differentiated surface power densities of 2800 W/m² and 4200 W/m² respectively, the corresponding heating body 200 is produced by means of the invention, by modifying (reducing) the equivalent specific resistance over all the surface area by adding suitable conductive patterns and by correctly positioning a partial break.

The invention is also applicable to the walls of environmental chambers.

Thus, when products kept (cold or frozen) in a refrigerated chamber should remain visible, as is the case in many current commercial premises, a refrigerated chamber is equipped with glass parts which convert it into a refrigerated “showcase” commonly known as “a refrigerated sales cabinet”. Several variants of these “showcases” exist.

Some have the form of a cabinet and then it is the door itself that is transparent, others consist of chests and it is the horizontal lid that is glazed so as to enable the contents to be observed, and still others consist of desk showcases and it is the part that separates the public from the merchandize that is glazed. Whatever the variants of these “showcases”, it is also possible to produce glazed walls so that all the contents are visible from the outside.

In these types of display cabinets, it is necessary for merchandize to remain perfectly visible to customers so that it is possible to preselect merchandize without opening the “showcase”. Consequently, it is necessary to prevent the glazed parts of the “showcases” from being covered with condensation.

The presence of condensed water or frost has drawbacks: a reduction of the field of vision through the glazed element, the appearance of mold, the formation of puddles on the floor, the transfer of moisture to the skin, the presence of rings on clothing, the risk of skin “sticking” to the frosted parts etc.

FIG. 3 shows a refrigerated chest 300 provided with an electric heating lid 310 according to a third embodiment of the invention.

The longitudinal walls 51 of the chest 300 are rectangular and the lateral walls 52, 53 are curved and receive the lid 310, composed of two sliding parts 311, 311′ made of bowed heated monolithic glass 1, 1′ with a complementary shape to the walls 52, 53 respectively.

Two heating elements are formed on the inner face of the glass 1, 1′, each of which is composed of:
a layer of fluorine-doped tin oxide 10, 10′ with a thickness chosen to be approximately 500 nm giving a specific resistance of 10 ohms,
a network 11, 11′ of silver dots 113, 113′ deposited on part of the layer 10, 10′ with a width equal to approximately 150 mm.

The dots 113, 113′ are positioned in parallel lines with two metal strips forming distributors 21 to 22′ placed in the region of the lateral edges of the glass 1, so as to prevent visibility from being harmed, and connected to the layer 10, 10′ for supplying this layer. The distributors 21 to 22′ are 400 mm apart.

The diameter of the dots 113, 113′ is 1 mm and the distance between the center of two adjacent dots is 2.1 mm. The degree of curvature is 17%.

Situated on a lower part of the lid 310 which is most sensitive to condensation, each network 11, 11′ makes it possible to heat this part preferentially, the temperature in this zone being adjusted to 40° C. To this end, the equivalent specific resistance of the heating element is made to fall to 7.5 ohms.

In a variant (not shown) a network of holes or insulating patterns in the layer, made by laser cutting or chemical etching, can be provided in the 300 mm wide less critical upper zone 12, 12′.

Also, from input data that are the supply voltage of 24 V, the dimensions of the glass 400×450 mm, the desired heating temperatures equal to 40° C. in the lower part and 35° C. in the upper part, the corresponding heating lid 310 is produced by means of the invention, by modifying (reducing) the equivalent specific resistance by adding suitable conductive patterns in the lower zone of the layer as well as by choosing the specific resistance of the unmodified upper zone of the layer.

In addition, in some types of glazing, condensation can appear on the glass and also on the frame supporting the glazing, especially if it is metallic and therefore apt to form a thermal bridge.

On account of their exposure to cold, the peripheral parts of the glazing, less insulated than the rest of the glazed surface, and elements supporting the glazing, are externally at a temperature that is lower than that of the ambient air, which produces condensation both on the glass and on the support.

In order to overcome these disadvantages, it is also known to heat the glazed element by means of a peripheral metal cord hidden in the frame supporting the glazed wall. This cord is not however completely satisfactory:
it cannot be easily made modular since its length depends entirely on the dimensions of the glazing,
it takes a long time to employ it since it is necessary to provide a perfectly sized groove in the thickness of the seal of the glass sheets,
since the contact area between the cord and the frame is small, the heat yield is low, and
given that it is supplied by a high-voltage electric current, it is essential to associate a safety device with it which breaks the circuit in the case of accidental breakage of the glass pane.

In order to overcome this disadvantage, the invention provides a door for a refrigerated chamber or cold door as shown in FIGS. 4a and 4b in a fourth embodiment of the invention.

The cold door 400 is composed of rectangular multiple glazing 1 enclosing at least two glass sheets separated by an air gap or vacuum and with a peripheral insert that produces thermal bridge phenomena.

Only the visible part of the door is shown (without the rebate and frame).

A layer of fluorine-doped tin oxide 10 is deposited on the inner face of the outer glass sheet 1 between two distributors 21, 22 positioned in the region of the lateral edges.

On the edge of the visible part, a network 11 of enamel dots based on silver 114 is deposited on the layer 10 so as to reinforce heating in this more sensitive peripheral zone. This localized heating can make it possible to dispense with the previously mentioned heating cord.

As shown in FIG. 4b, the network of patterns 11 is formed of a gradation of silver dots 114 positioned in parallel lines of which the size diminishes going towards the center of the pane, and in this way a temperature gradient is obtained having a targeted efficiency and an esthetic effect.

The diameter of the dots 114 varies from 2 mm to 0.5 mm for a degree of coverage extending from 67% to 0% from the edge to the center. The width of the network 11 is 30 mm. In the region of the lateral edges and 20 mm in the region of the longitudinal edges. The equivalent specific resistance falls to 131 ohms.

The layer is unmodified in the central part 12 that is to say it is not associated with patterns. In this unmodified zone 12, the specific resistance is chosen equal to 277 ohms.

Also, from the input data which are the supply voltage of 230 V, the dimensions of the glass 1500×700 mm, and the desired heating temperatures equal to 25° C. in the central zone and 35° C. on average in the edge, the corresponding cold door 400 is produced according to the invention, by modifying (reducing) the equivalent specific resistance by adding suitable conductive patterns on the edge as well as by choosing the specific resistance of the unmodified central zone.

FIG. 5 shows a plate warmer 500 according to a fifth embodiment of the invention. The plate warmer 500 consists of a rectangular piece of glass on which a layer of fluorine-doped tin oxide 10 is deposited between two distributors 21, 22 positioned in the region of the lateral edges.

Two networks are deposited on the layer 10, for example identical networks 11, 11′ of enamel dots based on silver 115, 115′, the latter forming centered and heating rounds for keeping cooked dishes or food hot. The equivalent specific resistance falls to 31 ohms with a degree of coverage of 51%.

The specific resistance of the non-functional zone 12 of the layer 10 is chosen equal to 62 ohms.

Also, from input data which are the supply voltage of 230 V, a diameter of the rounds of 200 mm, a distance between collectors of 800 mm, the desired temperatures equal to 80° C. in the non-functional zone and 120° C. in functional zones, the corresponding product 500 is produced by means of the invention by modifying (reducing) the equivalent specific resistance by adding suitable conductive patterns in the functional zones as well by choosing the specific resistance of the non-functional zone without patterns.

It is also possible to design a heating shelf with variable temperatures according to the type of food to be kept hot or indeed according to the desired heating geometry.

The invention also makes it possible to obtain products from other input data chosen from the dimensions and/or the temperature and/or the power and/or the supply voltage, from the moment that at least one of these parameters remains free.

The invention can also be applied when the distributors are positioned on adjacent edges or on the same side. The distributors can moreover be curved.

The invention can also be applied when the substrate has a trapezoidal or semicircular form.

1-21. (canceled)

22. An electric heating structure comprising:
a substrate; and
a heating element with a specific resistance and which comprises:
an electrically conductive layer deposited on one of faces of the substrate and supplied electrically, and
a network of patterns functionally connected to the electrically conductive layer.

23. The electric heating structure as claimed in claim 22, wherein the patterns have a rounded shape.

24. The electric heating structure as claimed in claim 22, wherein the patterns have a maximum size of 5 mm, preferably between 0.5 and 3 mm.

25. The electric heating structure as claimed in claim 22, wherein the patterns are arranged in a staggered manner.

26. The electric heating structure as claimed in claim 22, wherein the network of patterns cover an area, and a degree of coverage of the area lies between 5% and 70%, preferably between 10% and 40%.

27. The electric heating structure as claimed in claim 22, wherein the patterns have a max mum size diminishing, progressively, in a direction of an unmodified zone of the layer.

28. The electric heating structure as claimed in claim 22, wherein at least some of the patterns are insulating discontinuities formed in at least one zone of the layer.

29. The electric heating structure as claimed in claim 28, wherein at least some of the insulating discontinuities are rings preferably having a width of the order of 100 μm or less and/or are disks.

30. The electric heating structure as claimed in claim 28, wherein the substrate includes in an operating position an upper part and a lower part, wherein the network comprising the insulating discontinuities provided in the upper part.

31. The electric heating structure as claimed in claim 22, wherein at least some of the patterns are conducting dots having an electrical conductivity greater than that of the layer, the dots being positioned over at least one zone of the layer.

32. The electric heating structure as claimed in claim 31, wherein the conducting dots are based on silver.

33. The electric heating structure as claimed in claim 31, wherein the structure includes in the operating position an upper part and a lower part, the network comprising the conducting dots is provided in the lower part.

34. The electric heating structure as claimed in claim 22, wherein the network of patterns forms a strip.

35. The electric heating structure as claimed in claim 22, wherein the network of patterns forms a round.

36. The electric heating structure as claimed in claim 22, wherein the heating element is for led of at least two parts separated from each other by an electrically insulating zone, the network of patterns is present in at least one of the two parts.

37. The electric eating structure as claimed in claim 22, corresponding to an electric heating glazing comprising at least one sheet of lass.

38. The electric heating structure as claimed in claim 22, corresponding to one of the following elements: a heating body for a radiator or radiant panel, a heating front for a towel dryer or radiator an oven door, a glazed part for a heating shelf, a plate-warmer, an element of interior fittings, a radiant heating element for a building or service compartment, an element for frost-prevention and/or for maintaining temperature of sensitive products, a lid for a refrigerated chest, a glazed part for a refrigerated cabinet, and a glazed part of a desk showcase.

39. The electric heating structure as claimed in claim 22, wherein the conductive layer is based on a metal oxide, preferably fluorine-doped tin oxide.

40. The electric heating structure as claimed in claim 22, wherein the conductive layer has a thickness less than or equal to 1 μm.

41. The electric heating structure as claimed in claim 22, wherein the network patterns creates differentiated heating zones by modifying an equivalent specific resistance in a zone of the layer with the network of patterns and by modifying a specific resistance in a zone of the layer without a network.

42. The electric heating structure as claimed in claim 22, wherein the network of patterns creates a uniform temperature over the surface, or differentiated surface power densities, or differentiated temperatures.
